(19) United States
(12) Patent Application Publication
(10) Pub. No.: US 2022/0120334 A1
(43) Pub. Date: Apr. 21, 2022

(54) SHACKLE ASSEMBLY

(71) Applicant: SATURN INNOVATIONS LIMITED, Pukekohe (NZ)

(72) Inventor: Noel Stephen DUKE, Pukekohe (NZ)

(73) Assignee: SATURN INNOVATIONS LIMITED, Pukekohe (NZ)

(21) Appl. No.: 17/281,905

(22) PCT Filed: Oct. 11, 2019
(86) PCT No.: PCT/IB2019/058671

§ 371 Date: Mar. 31, 2021

(30) Foreign Application Priority Data
Oct. 12, 2018 (NZ) 747232

(51) Int. Cl. F16G 15/06

(52) U.S. Cl. CPC F16G 15/06

(57) ABSTRACT

A shackle assembly (200) comprising a shackle body (202), a shackle pin (102) and a clip member (104) is disclosed. The clip member (104) is pivotally mounted to the shackle pin (102) and is adapted to pivotally move with respect to the longitudinal axis of the shackle pin (102) between at least a first position and a second position. In the first position, the clip member (104) is adapted to engage to the shackle body (202) for allowing or at least assisting the shackle pin (102) to be secured to the shackle body (202). In the second position, the clip member (104) is adapted to be disengaged from the shackle body (202) and function as a lever for facilitating rotation of the shackle pin (102) about the longitudinal axis.

### FIELD OF THE INVENTION

The present invention relates to a shackle assembly.

### BACKGROUND TO THE INVENTION

Shackles such as D-shaped shackle and bow shackles are commonly used for the periodic connection or disconnection of chains, ropes or cables, and are commonplace in situations such as but not limited to the connection of lifting chains to loads, safety chains of automotive and industrial trailers and the rigging of small sailing vessels.

Connection and removal of such shackles is usually performed by hand and is often accompanied with difficulty to either sufficiently tighten the pin (or eye-bolt) to ensure safe coupling or inability to unscrew the pin without resorting to the use of a tool. For example, due to rust or similar factors, it can be too difficult to unscrew the pin by hand only without use of a tool.

Also, insufficient tightening of the pin in situations where the shackle is subject to vibration or an alternating load could result in the unintentional decoupling of the shackle with potentially dangerous consequences.

The foregoing drawbacks are just some of the problems encountered with conventional shackles.

### OBJECT OF THE INVENTION

It is an object of the present invention to provide a shackle assembly that overcomes or at least partially ameliorates some of the abovementioned disadvantages or which at least provides the public with a useful choice.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### SUMMARY OF THE INVENTION

In a first aspect, the invention resides in a shackle assembly comprising:

a shackle body comprising a first portion, a second portion, and an intermediate portion connecting the first and the second portions, the first and the second portions being spaced apart and located opposite to each other, the first portion comprising a first aperture and the second portion comprising a second aperture;

a shackle pin in a form of an elongated body extending along a longitudinal axis from a first end of the shackle pin to a second end of the shackle pin, wherein the first end and the second end are located opposite to each other, the shackle pin being configured to be attached to the shackle body so that the first and second apertures of the shackle body are both adapted to receive the shackle pin therethrough, thereby functioning as a cross member to the shackle body; and

a clip member, the clip member being pivotally mounted to the shackle pin at a pivoting point located at or near one of the first and second ends,

the clip member is adapted to pivotally move with respect to the longitudinal axis of the shackle pin between at least a first position where the clip member is adapted to engage to the shackle body (portion of the shackle body), and a second position where the clip member is adapted to be disengaged from the shackle body (portion of the shackle body) and function as a lever for facilitating rotation of the shackle pin about the longitudinal axis.

In one configuration, the clip member is adapted to engage to the shackle body via a snug fit or a snap fit arrangement.

In one configuration, the clip member is adapted to engage to the shackle body via a spring force.

In one configuration, the first and second apertures are co-axially aligned.

In one configuration, the shackle body is U-shape or substantially U-shape.

In one configuration, the shackle body is shaped to form as a bow shackle or a D shackle.

In one configuration, at least one of the ends of the shackle pin comprises a threaded portion (threaded arrangement) that is configured to engage with a complementary threaded portion (threaded arrangement) formed in at least one of the first and second apertures.

In one configuration, the shackle pin or at least a portion of the shackle pin is of cylindrical shape.

In one configuration, the shackle pin or at least a portion of the shackle pin is of cylindrical shape with a diameter that is slightly smaller than the diameter of the first and second apertures so that the first and second apertures can both snugly receive the shackle pin therethrough.

In one configuration, the clip member is made from a single piece of wire that is bent.

In one configuration, the clip member is made from a single piece wire that is formed as a loop (open or closed loop).

In one configuration, the loop of the wire is configured to engage with the portion of the shackle body that is proximal to the clip member for assisting the shackle pin to remain engaged with the first and second apertures of the shackle body.

In one configuration, the clip member or at least a portion of the clip member is formed as a curve or substantially a curve.

In one configuration, an upwardly extending portion is formed on the clip member, the upwardly extending portion extending in an upward direction from remaining portion of the clip member.

In one configuration, the upwardly extending portion is 90 degrees or substantially 90 degrees from remaining portion of the clip member.

In one configuration, the upwardly extending portion is located distal from the shackle pin (or distal from a pivoting point of a clip member).

In one configuration, the clip member is made from a metal.

In one configuration, the clip member is made from a metal which is at least one of a steel, aluminium, stainless steel (e.g. 316SS) and Titanium (e.g. 6A1-4V (Grade 5)).

In one configuration, the clip member is made from a non-metal.

In one configuration, the clip member is made from a non-metal which is plastic.

In one configuration, the first portion, second portion and the intermediate portion of the shackle body are integrally formed.

In one configuration, the shackle pin and the shackle body are both made from same material.

In one configuration, the clip member and the shackle body are both made from a metal.

In one configuration, the clip member and the shackle body are both made from a metal which is at least one of a steel, aluminium, stainless steel (e.g. 316SS) and Titanium (e.g. 6A1-4V (Grade 5)).

In one configuration, the clip member and the shackle body are both made from a non-metal.

In one configuration, the clip member and the shackle body are both made from a non-metal which is plastic.

In one configuration, the clip member has a shape or arrangements for allowing the clip member to snugly engage with the shackle body (a portion of the shackle body).

In one configuration, the shackle pin or the clip member comprises a pivot facilitating feature to which at least one complimentary feature of the clip member or the shackle pin is configured to be mounted to facilitate pivoting of the clip member with respect to the shackle pin.

In one configuration, the pivot facilitating feature comprises a hole or cavity through which the at least one complimentary feature is configured to be snugly and pivotably mounted to allow pivoting of clip member with respect to the shackle pin.

In one configuration, the pivot facilitating feature comprises two holes through which the at least one complimentary feature is configured to be snugly and pivotably mounted to allow pivoting of clip member with respect to the shackle pin.

In one configuration, the pivot facilitating feature comprises two holes, wherein the two holes are a first hole and a second hole, wherein the first hole is configured to snugly and pivotably receive a first complementary feature, and the second hole is configured to snugly and pivotably receive a second complementary feature to allow pivoting of the clip member with respect to the shackle pin.

In one configuration, the two holes are located adjacent to each other and at the same height from the second end of the shackle pin.

In one configuration, two holes are identical to each other in size and shape.

In one configuration, the two holes are circular holes.

In one configuration, the clip member is spring loaded

In one configuration, the clip member is biased to either a closed position in which the clip member is configured to engage with the shackle body during use or to an open position in which the clip member is configured to disengage with the shackle body during use.

In one configuration, the clip member is spring biased to either a closed position in which the clip member is configured to engage with the shackle body during use or to an open position in which the clip member is configured to disengage with the shackle body during use.

In one configuration, at or near one of the first and second ends of the shackle pin is a head through which the remaining portion of the shackle pin extends longitudinally as a shaft.

In one configuration, the pivot facilitating feature is formed at the head.

In one configuration, the head is sized and shaped to function as a gripping portion to facilitate gripping by a user's fingers and/or a gripping tool.

In one configuration, the head is planar, and the shaft is substantially cylindrical in shape.

In one configuration, the head comprises at least two cam surfaces that are adapted to facilitate pivoting of the clip member between at least the first position and the second position.

In one configuration, the head comprises at least three cam surfaces that are adapted to facilitate pivoting of the clip member between at least the first position, the second position and a third position.

In one configuration, when the clip member is in the third position, a portion or end of the clip member that is distal to a pivot point of the clip member is more distal to the shackle body than when the clip member is in the second position.

In one configuration, the clip member comprises a cantilever spring that is adapted to engage with one of the cam surfaces to allow the clip member to be and remain in a particular position.

In one configuration, the cantilever spring is mounted to the clip member at a mounting point that is proximal to an end of the clip member that is distal to the pivot point of the clip member.

In one configuration, the cantilever spring and the clip member are integrally formed.

In one configuration, the shackle pin comprises a flange adjacent to the head.

In one configuration, the flange is a circumferential flange, extending circumferentially around the external surface of the shackle pin.

In one configuration, the flange is integrally formed with the head.

In one configuration, when the shackle pin is attached to the shackle body and functions as the cross member to the shackle body, the circumferential flange is adapted to abut against a portion of the shackle body where one of the first and second apertures that is proximal to the clip member is located, so that the flange is located between the shackle body and the head.

In one configuration, wherein the clip member extends symmetrically along a second longitudinal axis and the angle between the longitudinal axis first longitudinal axis of the shackle pin and the second longitudinal axis is less than 90 degrees (preferably between 60 degrees to 80 degrees) when the clip member is engaged with the portion of the shackle body.

In one configuration, the angle between the longitudinal axis (first longitudinal axis) of the shackle pin and the second longitudinal axis is about 90 degrees or more (preferably between 90 degrees to 190 degrees) when the clip member is disengaged with the portion of the shackle body.

In a second aspect, the invention resides in a shackle pin assembly for engaging with a shackle body, the shackle pin assembly comprising:

a shackle pin having an elongated body extending along a longitudinal axis between a first end and a second end that are located opposite to each other; and

at least one clip member that is pivotally mounted or configured to be pivotably mounted to the shackle pin at or near one of the first and second ends,

wherein, in use, the clip member is adapted to pivotally move with respect to the longitudinal axis of the shackle pin between at least a first position where the clip member is adapted to engage to the shackle body (portion of the shackle body), and a second position where the clip member is adapted to be disengaged from the shackle body (portion of the shackle body) and function as a lever for facilitating rotation of the shackle pin about the longitudinal axis.

In one configuration, the clip member is adapted to engage to the shackle body via a snug fit or a snap fit arrangement.

In one configuration, the clip member is adapted to engage to the shackle body via a spring force.

In one configuration, the shackle body comprises a first portion, a second portion and an intermediate portion connecting the first and the second portions, the first and the second portions being spaced apart and located opposite to each other, the first portion comprising a first aperture and the second portion comprising a second aperture.

In one configuration, the first and second apertures are co-axially aligned.

In one configuration, the shackle body is U-shape or substantially U-shape.

In one configuration, the shackle body is shaped to form a bow shackle or a D shackle.

In one configuration, the shackle pin is configured to be attached to the shackle body so that the first and second apertures of the shackle body are both adapted to receive the shackle pin therethrough, thereby functioning as a cross member to the shackle body.

In one configuration, at least one of the ends of the shackle pin comprises a threaded portion (threaded arrangement) that is configured to engage with a complementary threaded portion (threaded arrangement) formed in at least one of the first and second apertures.

In one configuration, the shackle pin or at least a portion of the shackle pin is of cylindrical shape.

In one configuration, the shackle pin or at least a portion of the shackle pin is of cylindrical shape with a diameter that is slightly smaller than the diameter of the first and second apertures so that the first and second apertures can both snugly receive the shackle pin therethrough.

In one configuration, the clip member is made from a single piece of wire that is bent.

In one configuration, the clip member is made is made from a single piece wire that is formed as a loop (open or closed loop).

In one configuration, the loop of the wire is configured to engage with the portion of the shackle body that is proximal to the clip member for assisting the pin to remain engaged with the first and second apertures of the body shackle body.

In one configuration, the clip member or at least a portion of the clip member is formed as a curve or substantially a curve.

In one configuration, an upwardly extending portion is formed on the clip member, the upwardly extending portion extending in an upward direction from the remaining portion of the clip member.

In one configuration, the upwardly extending portion is 90 degrees or substantially 90 degrees from remaining portion of the clip member.

In one configuration, the upwardly extending portion is located distal from the shackle pin (or distal from a pivoting point of the clip member).

In one configuration, the clip member is made from a metal.

In one configuration, the clip member is made from a metal which is at least one of a steel, aluminium, stainless steel (e.g. 316SS) and Titanium (e.g. 6A1-4V (Grade 5)).

In one configuration, the clip member is made from a non-metal.

In one configuration, the clip member is made from a non-metal which is plastic.

In one configuration, the first portion, second portion and the intermediate portion of the shackle body are integrally formed.

In one configuration, the shackle pin and the shackle body are both made from same material.

In one configuration, the clip member and the shackle body are both made from a metal.

In one configuration, the clip member and the shackle body are both made from a metal which is at least one of a steel, aluminium, stainless steel (e.g. 316SS) and Titanium (e.g. 6A1-4V (Grade 5)).

In one configuration, the clip member and the shackle body are both made from a non-metal.

In one configuration, the clip member and the shackle body are both made from a non-metal which is plastic.

In one configuration, the clip member has a shape or arrangements for allowing it to snugly engage with the shackle body or (portion of the shackle body).

In one configuration, the shackle pin or the clip member comprises a pivot facilitating feature to which at least one complimentary feature of the clip member or the shackle pin is configured to be mounted to facilitate pivoting of the clip member with respect to the shackle pin.

In one configuration, the pivot facilitating feature comprises a hole or cavity through which the at least one complimentary feature is configured to be snugly and pivotably mounted to allow pivoting of clip member with respect to the shackle pin.

In one configuration, the pivot facilitating feature comprises two holes through which the at least one complimentary feature is configured to be snugly and pivotably mounted to allow pivoting of clip member with respect to the shackle pin.

In one configuration, the pivot facilitating feature comprises two holes, wherein the two holes are a first hole and a second hole, wherein the first hole is configured to snugly and pivotally receive a first complementary feature, and the second hole is configured to snugly and pivotally receive a second complementary feature to allow pivoting of the clip member with respect to the shackle pin.

In one configuration, the two holes are located adjacent to each other and at the same height from the second end of the shackle pin.

In one configuration, the two holes are identical to each other in size and shape.

In one configuration, the two holes are circular holes.

In one configuration, the clip member is spring loaded.

In one configuration, the clip member is biased to either a closed position in which the clip is configured to engage with the shackle body during use or to an open position in which the clip is configured to either engage or disengage the shackle during use.

In one configuration, the clip member is spring biased to either a closed position to which the clip member is configured to engage with the shackle body during use or to an open position in which the clip member is configured to disengage with the shackle body during use.

In one configuration, at or near one of the first and second ends of the shackle pin is a head through which the remaining portion of the shackle pin extends longitudinally as a shaft.

In one configuration, the pivot facilitating feature is formed at the head.

In one configuration, the head is sized and shaped to function as a gripping portion to facilitate gripping by a user's fingers and/or a gripping tool.

In one configuration, the head is planar, and the shaft is substantially cylindrical in shape.

In one configuration, the head comprises at least two cam surfaces that are adapted to facilitate pivoting of the clip member between at least the first position and the second position.

In one configuration, the head comprises at least three cam surfaces that are adapted to facilitate pivoting of the clip member between at least the first position and the second position and a third position.

In one configuration, when the clip member is in the third position, a portion or an end of the clip member that is distal to a pivot point of the clip member is more distal to the shackle body than when the clip member is in the second position.

In one configuration, the clip member comprises a cantilever spring that is adapted to engage with one of the cam surfaces to allow the clip member to be and remain in a particular position.

In one configuration, the cantilever spring is mounted to the clip member at a mounting point that is proximal an end of the clip member that is distal to a pivot point of the clip member.

In one configuration, the cantilever spring and the clip member are integrally formed.

In one configuration, the shackle pin comprises a flange adjacent to the head.

In one configuration, the flange is a circumferential flange, extending circumferentially around the external surface of the shackle pin.

In one configuration, the flange is integrally formed with the head.

In one configuration, when the shackle pin is attached to the shackle body and functions as a cross member to the shackle body, the circumferential flange is adapted to abut against a portion of the shackle body where one of the first and second apertures that is proximal to the clip member is located, so that the flange is located between the shackle body and the head.

In one configuration, wherein the clip member extends symmetrically along a second longitudinal axis and the angle between the longitudinal axis (first longitudinal axis) of the shackle pin and the second longitudinal axis is less than 90 degrees (preferably between 60 degrees to 80 degrees) when the clip member is engaged with the shackle body.

In one configuration, the angle between the longitudinal axis of the shackle pin and the second longitudinal axis is about 90 degrees or more (preferably between 90 degrees to 190 degrees) when the clip member is disengaged with the shackle body.

In one configuration, the shackle pin assembly as defined in any one of the above statements is configured to engage with a shackle body of a shackle assembly, wherein the shackle assembly is the one as defined in any one of the above statements.

In a third aspect, the invention resides in a shackle assembly comprising:

a shackle body having a first portion, a second portion and an intermediate portion connecting the first and the second portions, the first and the second portions being spaced apart and located opposite to each other, the first portion comprising a first aperture and the second portion comprising a second aperture; and

a cross member extending along a longitudinal axis of the cross member from a first end of the cross member to a second end of the cross member, wherein the first end and the second end are located opposite to each other, the cross member having a clip member that is pivotally attached to the cross member at or proximal to one of the first and second ends;

wherein when in an assembled position, the cross member is configured to be attached to the body so that the first and second apertures of the shackle body are both adapted to receive the cross member therethrough,

wherein when in the assembled position, the clip member is adapted to pivotally move with respect to the cross member between a secure position and an unsecured position,

wherein when in the secured position the clip member is configured to engage with a portion of the shackle body that is proximal to the clip member for allowing or at least assisting the cross-member to remain in the assembled position, and

wherein when in the unsecured position, the clip member is configured to disengage with the shackled body and function as a lever for assisting in full or partial detachment of the cross member from the shackle body.

In one configuration, when in the second position, the clip member is configured to engage to the shackle body via a snug fit or snap fit arrangement.

In one configuration, the clip member is adapted to engage to the shackle body via a spring force.

In one configuration, the first and second apertures are co-axially aligned.

In one configuration, the body is of U-shape or substantially U-shape.

In one configuration, the first portion, second portion and the intermediate portion of the shackle body are integrally formed.

In one configuration, the shackle body is shaped to form a bow shackle or a D shackle.

In one configuration, cross member and the shackle body are both made from same material.

In one configuration, the cross member and the body of the shackle are both made from a metal

In one configuration, the cross member and the body of the shackle are both made from a metal which is at least one of a steel, aluminium, stainless steel (e.g. 316SS) and Titanium (e.g. 6A1-4V (Grade 5)).

In one configuration, the cross member and the body of the shackle are both made from a non-metal.

In one configuration, the cross member and the body of the shackle are both made from a non-metal which is plastic.

In one configuration, the cross member is the shackle pin assembly as defined in any one of the above statements.

In a fourth aspect, the invention resides in a clip member for clipping to a portion of a shackle body, the clip member being adapted to engage with a shackle pin that is elongated and extends along a longitudinal axis of the shackle pin from a first end of the shackle pin to the second end of the shackle pin, wherein the clip member is adapted to engage pivotally at or near either one of the first end and the second end of the shackle pin, wherein when engaged with the shackle pin, the clip member is adapted to function as a lever for facilitating rotation of the shackle pin about the longitudinal axis.

In one configuration, the clip member is made from a single piece of wire that is bent.

In one configuration, the clip member is made from a single piece wire that is formed as a loop (open or closed loop).

In one configuration, the loop of the wire is configured to engage with the portion of the shackle body that is proximal to the clip member for assisting the pin to remain engaged with the first and second apertures of the shackle body.

In one configuration, the clip member or a portion of the clip member is formed as a curve or substantially a curve.

In one configuration, an upwardly extending portion is formed on the clip member, the upwardly extending portion extending in an upward direction from remaining portion of the clip member.

In one configuration, the upwardly extending portion is 90 degrees or substantially 90 degrees from remaining portion of the clip member.

In one configuration, the upwardly extending portion is located distal from the shackle pin (or distal from a pivoting point of a clip member).

In one configuration, the clip member is made from a metal.

In one configuration, the clip member is made from a metal which is at least one of a steel, aluminium, stainless steel (e.g. 316SS) and Titanium (e.g. 6A1-4V (Grade 5)).

In one configuration, the clip member is made from a non-metal.

In one configuration, the clip member is made from a non-metal which is plastic.

In one configuration, the clip member as defined in any one of the above statements is configured to clip to a portion of a shackle body of a shackle assembly, wherein the shackle assembly is the one of the above statements.

In a fifth aspect, the invention resides in a shackle pin extending longitudinally at a longitudinal axis from a first end of the clip member to a second end of the clip member, wherein at or near one of the first and second ends of the shackle pin is a pivoting arrangement to a clip member so that when the clip member is engaged with the shackle pin at the pivoting arrangement, the clip member is adapted to function as a lever for facilitating rotation of the shackle pin about the longitudinal axis.

In one configuration, at least one of the first and second ends of the shackle pin comprises a threaded portion (threaded arrangement).

In one configuration, the shackle pin or at least a portion of the shackle pin is of cylindrical shape.

In one configuration, the shackle pin is made from a metal.

In one configuration, the shackle pin is made from a metal which is at least one of a steel, aluminium, stainless steel (e.g. 316SS) and Titanium (e.g. 6A1-4V (Grade 5)). such as but not limited to steel, aluminium and/or iron.

In one configuration, the shackle pin is made from a non-metal.

In one configuration, the shackle pin is made from a non-metal which is plastic.

In one configuration, the pivoting arrangement comprises a pivot facilitating feature to which at least one complimentary feature of the clip member is configured to be mounted to facilitate pivoting of the clip member with respect to the shackle pin.

In one configuration, the pivot facilitating feature comprises a hole which the at least one complimentary feature of the clip member is configured to be snugly and pivotably mounted to allow pivoting of clip member with respect to the shackle pin.

In one configuration, the pivot facilitating feature comprises two holes through which the at least one complimentary feature is configured to be snugly and pivotably mounted to allow pivoting of clip member with respect to the shackle pin.

In one configuration, the pivot facilitating feature comprises two holes, wherein the two holes are a first hole and a second hole, wherein the first hole is configured to snugly and pivotably receive a first complementary feature, and a second hole is configured to snugly and pivotably receive a second complementary feature to allow pivoting of the clip member with respect to the shackle pin.

In one configuration, the two holes are located adjacent to each other and at the same height from the second end of the shackle pin.

In one configuration, two holes are identical to each other in size and shape.

In one configuration, the two holes are circular holes.

In one configuration, at or near one of the first and second ends of the shackle pin is a head through which the remaining portion of the shackle pin extends as a shaft.

In one configuration, the pivot facilitating feature is formed at the head.

In one configuration, the head is sized and shaped to function as a gripping portion to facilitate gripping by a user's fingers and/or gripping tool.

In one configuration, the head is planar, and the shaft is substantially cylindrical in shape.

In one configuration, the head comprises at least two cam surfaces that are adapted to facilitate pivoting of the clip member between at least two positions.

In one configuration, the head comprises at least three cam surfaces that are adapted to facilitate pivoting of the clip member between at least the first position, the second position and a third position.

In one configuration, when the clip member is in the third position, a portion or end of the clip member that is distal to a pivot point of the clip member is more distal to the shackle body than when the clip member is in the second position.

In one configuration, the shackle pin comprises a flange adjacent to the head.

In one configuration, the flange is a circumferential flange, extending circumferentially around the external surface of the shackle pin.

In one configuration, the flange is integrally formed with the head.

In one configuration, the shackle pin as defined in any one of the above statements is part of a shackle assembly, wherein the shackle assembly is the one as defined in any one of the above statements.

In a sixth aspect, the invention resides in a method of using a shackle assembly, the method comprising:

providing the shackle assembly as defined in any one of the above statements;

attaching the shackle pin to the shackle body so that the first and second apertures of the shackle body both receive the shackle pin therethrough, thereby allowing the shackle pin to function as a cross member to the shackle body; and

pivotably moving the clip member with respect to the longitudinal axis of the shackle between at least a first position where the clip member is adapted to engage (such as via snug fit or snap fit arrangement or spring force) to the shackle body (portion of the shackle body), and a second position where the clip member is adapted to be disengaged from the shackle body (portion of the shackle body) and function as a lever that can facilitate rotation of the shackle pin about its longitudinal axis.

In one configuration, the method comprises pivotally moving the clip member to a third position which is different from the first position and the second position.

In one configuration, when in the third position, an end of the clip member that is distal to a pivot point of the clip member is more distal to the shackle body than when in the second position.

In one configuration, the method further comprises: using the clip member as the lever or a handle to rotate the shackle pin about the longitudinal axis of the shackle pin thereby causing the shackle pin to be removed from both the first and second apertures of the shackle body.

In one configuration, the method further comprises: using the clip member as the lever or a handle to pull the shackle pin causing the shackle pin to be removed from both the first and second apertures of the shackle body.

In one configuration, the method further comprises: using the clip member as a lever or a handle to rotate the shackle pin about the longitudinal axis of the shackle pin thereby causing the shackle pin to be received through both the first and second apertures of the shackle body.

In one configuration, the method comprises, using the clip member as the lever or a handle to pull the shackle pin causing the shackle pin to be inserted to both the first and second apertures of the shackle body.

In one configuration, the method further comprises using the clip member to allow the shackle pin to be secured to the shackle body when in the first position.

In one configuration, the method further comprises using the clip member to allow the shackle pin to remain secured to the shackle body when in the first position.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However, it is to be understood that the invention may assume various alternative variations, except where expressly specified to the contrary. It is also to be understood that the specific devices illustrated in the attached drawings, and described in the following description are simply exemplary embodiments of the invention. Hence, specific dimensions and other physical characteristics related to the embodiments disclosed herein are not to be considered as limiting.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprises’ or ‘comprised’ or ‘comprising’ is used in relation to the apparatus or to one or more steps in a method or process.

As used hereinbefore and hereinafter, the term “and/or” means “and” or “or”, or both.

As used hereinbefore and hereinafter, “(s)” following a noun means the plural and/or singular forms of the noun.

When used in claim and unless stated otherwise, the word ‘for’ is to be interpreted to mean only ‘suitable for’, and not for example, specifically ‘adapted’ or ‘configured’ for the purpose that is stated.

### BRIEF DESCRIPTION OF THE DRAWINGS

The invention will now be described by way of example only and with reference to the drawings in which:

FIG. 1A shows a perspective view of one preferred example/embodiment of a shackle pin assembly according to the present invention comprising one preferred example/embodiment of a clip member of the present invention, the clip member being in a first position.

FIG. 1B shows a top plan view of the shackle pin assembly of FIG. 1A.

FIG. 1C shows a right-side elevation view of the shackle pin assembly of FIG. 1A.

FIG. 1D shows a left-side elevation view of the shackle pin assembly of FIG. 1A.

FIG. 1E shows a bottom plan view of the shackle pin assembly of FIG. 1A.

FIG. 1F shows a perspective view of the shackle pin assembly of FIG. 1A but with the clip member being pivoted to a second position that is different from the position shown in FIG. 1A.

FIG. 1G a perspective view of the shackle pin assembly of FIG. 1F showing a portion/arrangement formed on the shackle pin.

FIG. 2A is a perspective view of a shackle assembly according to one preferred embodiment of the present invention where the shackle pin is shown in a first position in which the clip member is engaged to a portion of the shackle body.

FIG. 2B shows a side elevation view of the shackle assembly of FIG. 2A.

FIG. 2C shows a top plan view of the shackle assembly of FIG. 2A.

FIG. 2D shows a front view of the shackle assembly of FIG. 2A.

FIG. 2E is a perspective view of a shackle assembly of FIG. 2A but with the clip member shown in a second position in which it is dis-engaged from the shackle body.

FIG. 2F is a bottom plan view of a shackle assembly of FIG. 2A but with the clip member shown in a second position in which it is disengaged from the shackle body.

FIG. 3A is a perspective view of a shackle assembly according to another preferred embodiment of the present invention where the shackle pin is shown in a first position in which the clip member is engaged to a portion of the shackle body.

FIG. 3B shows a side elevation view of the shackle assembly of FIG. 3A.

FIG. 3C is a perspective view of a shackle assembly of FIG. 3A but with the clip member shown in a second position in which it is dis-engaged from the shackle body.

FIG. 3D is a side elevation view of a shackle assembly of FIG. 3C.

FIG. 4A is a side elevation view of a shackle assembly according to yet another preferred embodiment of the present invention where a shackle pin is shown in a closed position in which the clip member is engaged to a portion of the shackle body.

FIG. 4B shows a front view of the shackle assembly of FIG. 4A in the closed position.

FIG. 4C shows a side elevation view of the shackle assembly of FIG. 4A where the shackle pin is shown at or near midway/intermediate position in which the clip member is disengaged from the shackle body.

FIG. 4D shows a front view of the shackle assembly of FIG. 4A at or near midway/intermediate position.

FIG. 4E is a side elevation view of the shackle assembly of FIG. 4A but with the clip member shown in an open position in which it is disengaged from the shackle body.

FIG. 4F shows a front view of the shackle assembly of FIG. 4A in the open position.

FIG. 4G is a cross sectional view of a shackle assembly of FIG. 4A along the C-C axis shown in FIG. 4b.

FIG. 4H is a cross sectional view of a shackle assembly of FIG. 4A along the M-M axis shown in FIG. 4d.

FIG. 4I is a detail view of portion E of FIG. 4H.

FIG. 4J is a cross sectional view of a shackle assembly of FIG. 4A along the O-O axis shown in FIG. 4F.

FIG. 4K shows an example of a shackle pin for use with the shackle assembly of FIG. 4A.

FIG. 4L shows an exploded view of the shackle assembly of FIG. 4A.

FIG. 4M shows another exploded view of the shackle assembly of FIG. 4A.

FIG. 4N shows another exploded view of the shackle assembly of FIG. 4A, this figure shows threaded portion formed on the shackle pin and the complementary threaded portion/arrangement formed on the shackle body.

FIG. 5A is a perspective view of a shackle assembly according to a further preferred embodiment of the present invention where the shackle pin is shown in a first position in which the clip member is engaged to a portion of the shackle body.

FIG. 5B shows a side elevation view of the shackle assembly of FIG. 5A.

FIG. 5C shows a front view of the shackle assembly of FIG. 5A.

FIG. 5D is a perspective view of a shackle assembly of FIG. 5A but with the clip member shown in a second position in which it is dis-engaged from the shackle body.

FIG. 5E shows a side elevation view of the shackle assembly of FIG. 5D.

FIG. 5F shows a front view of the shackle assembly of FIG. 5F.

### DETAILED DESCRIPTION

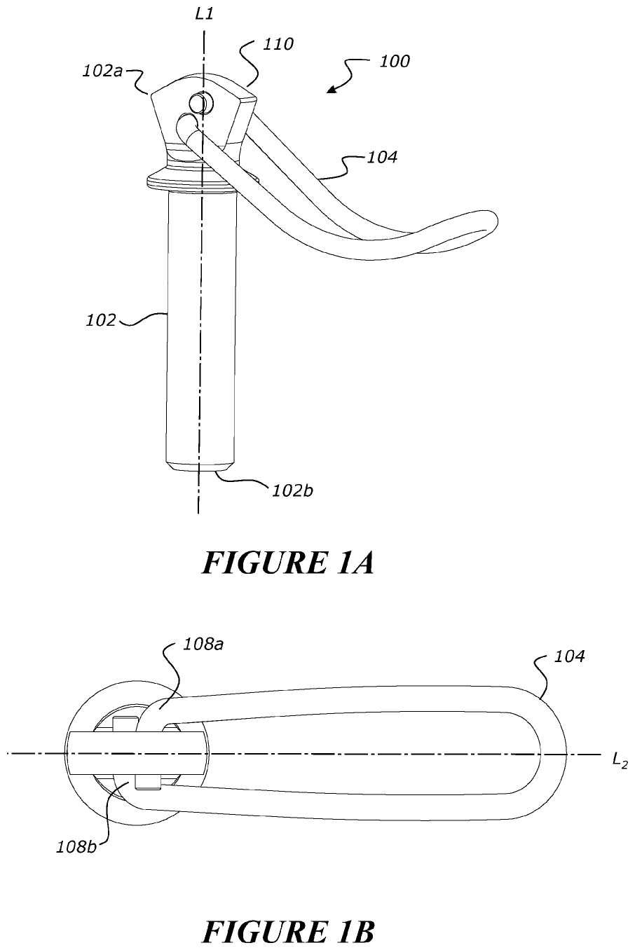

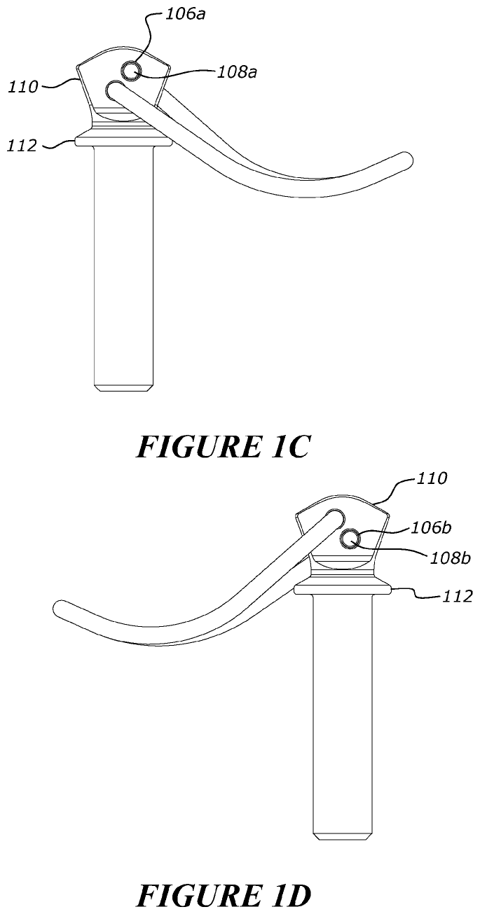

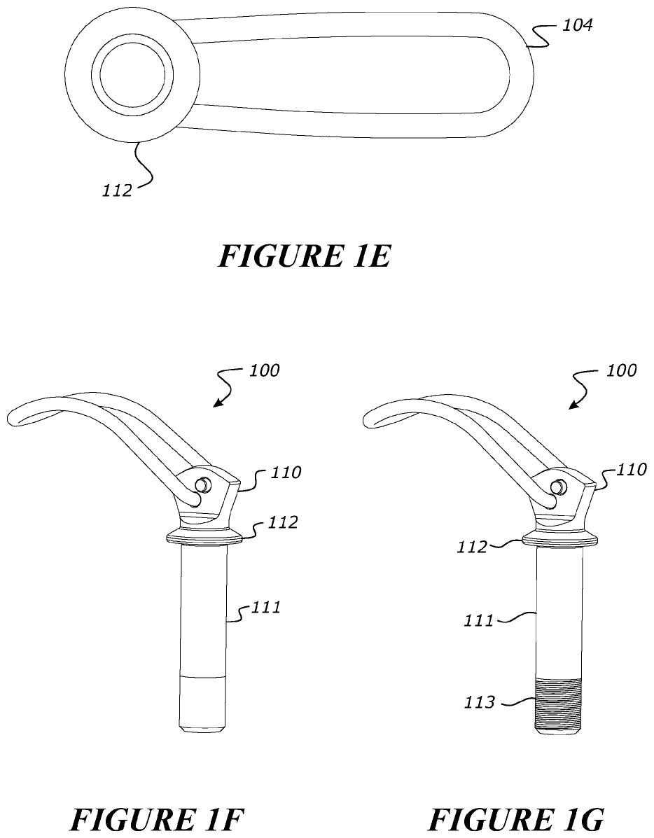

Reference will now be made to the accompanying drawings in which FIGS. 1A to 1G show one preferred example/embodiment of a shackle pin assembly 100 according to the present invention.

The shackle pin assembly 100 is configured to be engaged with a shackle body. This will be described in more detail later in the specification.

As shown in FIGS. 1A to 1G, the shackle pin assembly 100 may comprise a shackle pin 102 having or being in a form of an elongated body with two end portions/ends 102a, 102b that are located opposite to each other. At least one clip member 104 may be pivotally mounted to the shackle pin 102 at or near one of the two ends 102a, 102b. In this example, the clip member 104 is shown to be pivotably mounted to the shackle pin 102 at or near a first end 102a. Such pivoting arrangement can allow the clip member to pivotably move between a position shown in FIG. 1A and a position shown in FIG. 1G.

Specifically, as a pivoting arrangement, the shackle pin 102 may comprise a pivot facilitating feature (at or proximal to one of the first and second ends) to which at least one complimentary feature of the clip member 104 is mounted to facilitate pivoting of the clip member 104 with respect to the shackle pin 102. In the example, shown in FIGS. 1A-1G, the pivot facilitating feature comprises two holes 106a, 106b to which complimentary features (or lugs) 108a, 108b of the clip member 104 may be snugly and at the same time pivotably mounted/fitted to allow pivoting of clip member 104 with respect to the shackle pin. As shown, two holes 106a, 160b may be circular holes.

The shackle pin 102 or at least a portion of its may be of cylindrical shape as shown in FIGS. 1A-1G.

As it can be seen from FIGS. 1A-1G, at or near one of the ends, in this case, the first end 102a of the shackle pin may be formed as a gripping portion to facilitate gripping (gripping of the shackle pin) e.g. by a user's finger's or a gripping tool. The gripping portion 110 is a head of the shackle pin 102 and remaining portion of the shackle pin 104 may extend longitudinally from the head 110. The pivot facilitating features such as holes 106a, 106b may be formed at the gripping portion/head 110. In the example shown in FIGS. 1A-1G, the gripping portion is the head 110 and the remaining portion of the shackle pin 102 is formed as a shaft. The head 110 could be of many other suitable shapes. For example, the head 110 and the shaft may both be cylindrical in shape with the diameter of the head 110 being larger than the diameter of the shaft 111. As shown, the head 110 may be planar and the shaft 111 may be cylindrical in shape.

The shackle pin 102 may comprise a flange 112 adjacent of the head 110. In this example shown, the flange 112 is located between the head 110 and the shaft 111.

As will be described in detail later, the clip member 104 may be adapted to engage (such as via snug fit or snap fit arrangement or spring force/under spring tension) to a shackle body and may also function as a lever for facilitating rotation of the shackle pin 102 about the longitudinal axis L1 of the shackle pin 102. The clip member 104 may be made from a metal such as but not limited to steel, aluminium, stainless steel (e.g. 316SS) and/or Titanium (e.g. 6A1-4V (Grade 5)). Alternatively, the clip member 104 may be made from a suitable non-metal such as but not limited to plastic and/or carbon fibre.

The clip member 104 or at least a portion of the clip member 104 may be formed as a curve or substantially a curve as shown in FIGS. 1A to 1F. The clip member 104 may be made from a single piece of wire that is bent. Specifically, as shown in FIGS. 1A-1G, the clip member 104 may be made from a single piece wire that is formed as a loop which can be an open loop or a closed loop. As will be described later, such loop of wire may be configured to engage with the portion of the shackle body that is proximal to the clip member for assisting the shackle pin 102 to remain engaged with the first and second apertures of the shackle body.

As shown in FIG. 1G, the shackle pin 100 may optionally have a threaded portion as 113 as will be described later in more detail.

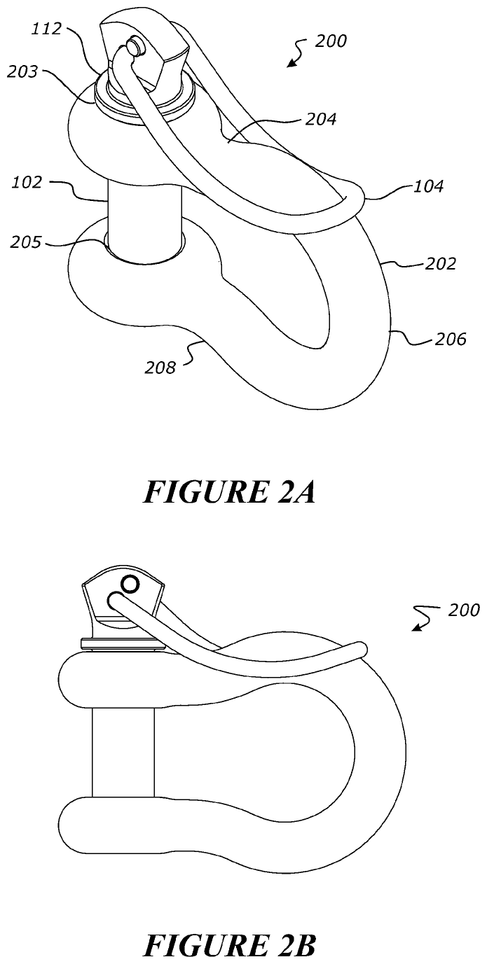

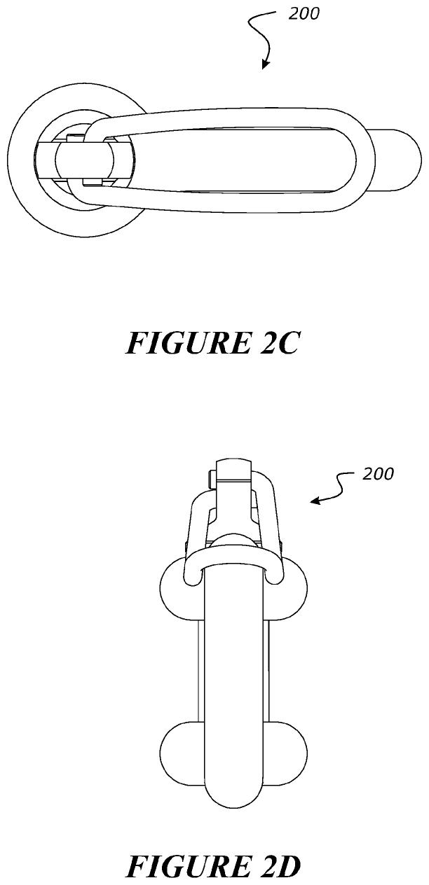

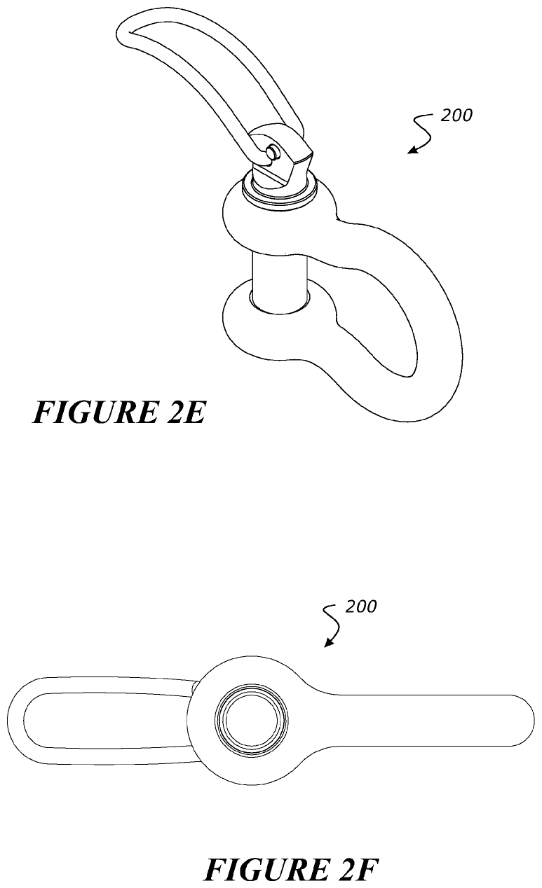

FIGS. 2A-2F show a shackle assembly 200 according to one preferred embodiment of the present invention. The shackle assembly 200 comprises a shackle body 202 having a first portion 204, a second portion 208 and an intermediate portion 206 connecting the first portion 204 and the second portion 208. As shown in the FIGS. 2A-2F, the first portion 204 and the second portion 208 are spaced apart and located opposite to each other. The intermediate portion 206 may be of C-shape or substantially C shaped, the first portion 204 may comprises a first aperture 203 and the second portion 208 may comprise a second aperture 205. Preferably, the first portion 204, the second portion 208 and the intermediate portion 206 are integrally formed. The shackle body 202 in example of FIGS. 2A-2F is shaped to form a bow shackle.

The first and second apertures 203, 205 may be co-axially aligned as shown in in FIGS. 2A-2F.

The shackle assembly 200 may comprise a cross member which in this example is the shackle pin 102 and a clip member 104. Basically, the shackle assembly 200 in embodiment shown in FIGS. 2A-2F comprises shackle pin assembly 100 as described above with reference to FIGS. 1A-1G.

As shown in FIGS. 2A-2F, the shackle pin 102 can attach to the shackle body 202 so that the first aperture 203 and second aperture 205 of the shackle body 202 are both adapted to receive the shackle pin 102 therethrough. The shackle pin 102 can therefore function as a cross member to the shackle body 202. The shackle pin 102 or at least a portion of the shackle pin 102 may be of cylindrical shape with a diameter that is slightly smaller than the diameter of the first and second apertures 203, 205 so that the first and second apertures 203, 205 can both snugly receive the shackle pin 102 therethrough.

When the shackle pin 102 functions as a cross member to the shackle body 202, the clip member 104 may be adapted to pivotally move with respect to the longitudinal axis L1 of the shackle pin 102 between a first position as shown in FIGS. 2A-2D and a second position as shown in FIGS. 2E-2F. In the first position, the clip member 104 is adapted to engage, preferably, via snug fit or snap fit arrangement or spring force/under spring tension, to the shackle body 202 (portion of the shackle body 202) as shown in FIGS. 2A-2D. The engagement of the clip member 104 to the shackle body 202 can allow the shackle pin 102 to be secured to the shackle body 202 without any additional engagement means. Similarly, in the second position as shown in FIGS. 2E to 2F, the clip member 104 is adapted to be disengaged from the shackle body 202. When in the second position, the clip member 104 may function as a lever for facilitating rotation of the shackle pin 202 about its longitudinal axis L1.

At least one of the ends 102a and 102b of the shackle pin may optionally comprise a threaded arrangement/threaded portion that is configured to engage with a complementary threaded arrangement/threaded portion formed in at least one of the first and second apertures 203, 205 of the shackle body 202. FIG. 1G shows an example of a such threaded portion 113. The threaded portion 113 may extend from one of the ends in this case end 102b towards the direction of the head 112. Preferably, the threaded portion 113 may extend at least quarter of the total length of the shaft 111. Such threaded arrangement can further assist the shackle pin 102 to be secured to the shackle body 202. However, it can be appreciated that even if the threaded portion 113 is not tightly engaged with the complementary threaded portion formed in first and/or second apertures 203, 205 of the shackle body 202, the shackle pin 102 may still remain secured to the shackle body 202 due to the clip member 104 being engaged to the shackle body 202. Therefore, due to the clip member 104, the engagement at the threaded portions no longer needs to be tight in order to be secure. That is, as long as the shackle pin 102 is properly engaged into the shackle body 202, and the clip member 104 is in the secure position, the functionality of the shackle is not compromised, thus negating the necessity to have the shackle pin 102 screwed in tight for security.

The shackle pin 102 and the shackle body 202 may both be made from the same material or different materials. Some example of suitable materials are aluminium, iron, steel, stainless steel (e.g. 316SS) and/or Titanium (e.g. 6A1-4V (Grade 5)) plastic and/or carbon fibre. Similarly, it is possible that the clip member 104 and the shackle body 202 are both made from the same material or different material. Some example of suitable materials are aluminium, iron, steel, stainless steel (e.g. 316SS) and/or Titanium (e.g. 6A1-4V (Grade 5)) plastic and/or carbon fibre.

The clip member 104 may be spring loaded.

The clip member 104 may be biased (preferably spring biased) to either the first position which is a closed or locked or engaged position as shown in FIGS. 2A-2D in which the clip member 104 is configured to engage with the shackle body 202 or to the second position which is an open or disengaged position as shown in FIGS. 2E-2F in which the clip member is configured to disengage with the shackle body 202.

As it can be seen in FIGS. 2A to 2F, when the shackle pin 102 is attached to the shackle body 202, the shackle pin 102 may function as a cross member to the shackle body 202. The circumferential flange 112 may abut against a portion of the shackle body 202 where one of the apertures, in this example aperture 203, that is proximal to the clip member 104 is located. The flange 112 of the shackle pin 102 may therefore be sandwiched/located between the shackle body 202 and the head 110.

As shown in FIG. 1B, the clip member 104 may extend symmetrically along a longitudinal axis L2. When the clip member 104 is engaged with the portion of the shackle body 202 as shown in FIGS. 2A to 2D, an angle between the longitudinal axis L1 of the shackle pin 102 and the longitudinal axis L2 of the clip member 104 may be less than 90 degrees (preferably between 60 degrees to 80 degrees).

Similarly, when the clip member 104 is disengaged with the portion of the shackle body 202 as shown in FIGS. 2E to 2F, an angle between the longitudinal axis of the shackle pin 102 and the longitudinal axis L2 of the clip member 104 may be 90 degrees or more. (preferably between 90 degrees to 190 degrees).

One preferred method of using the shackle assembly 200 will now be described.

To attach the shackle pin 102 to the shackle body 202, the shackle pin 102 may first be inserted into the first and second apertures 203, 205 of the shackle body 202 so that both the first and second apertures 203, 205 receive the shackle pin 102 therethrough. If desired or necessary, the clip member 104 may be used as a lever or handle to rotate the shackle pin 102 about its longitudinal axis thereby causing the shackle pin 102 to be properly (and/or tightly) received through both the first and second apertures of the shackle body 202. It can be appreciated that if the shackle pin 102 comprises a threaded arrangement/threaded portion 113 that is configured to engage with a complementary threaded arrangement/threaded portion(s) in at least one of the first and second apertures 203, 205 of the shackle body 202, then using the lever in such a manner can also assist in tightly engaging the shackle pin 102 to the apertures 203, 205 of the shackle body 202.

Once the shackle pin 102 has been properly received within the first and second apertures 203, 205, the clip member 104 may be pivotably moved from the disengaged position such as one shown in FIGS. 2E-2F, to the engaged position such as one shown in FIGS. 2A-2D. By engaging with the shackle body 202 in such a manner, the clip member 104 can function as a safety keeper or a catch. As mentioned above, the engagement of the clip member 104 to the shackle body 202 allows the shackle pin 102 to be secured to the shackle body 202. The engagement of the clip member 104 to the shackle body 202 may allow the shackle pin 102 to remain secured to the shackle body 202 without necessarily requiring any other engagement features or arrangements. Hence, although the threaded arrangements as described above is preferable, that may be optional. A person skilled in the art will appreciate that such clip member 104 can then prevent (or at least assist to prevent) unintentional rotation of the shackle pin 102 thereby preventing (or at least assist in preventing) disengagement of the shackle pin 102 from the shackle body 202.

To detach or disengage the shackle pin 102 from the shackle body 202, the above method/process may be reversed. In other words, the clip member 104 may first be pivotably moved from the engaged position such as one shown in FIGS. 2A-2D, to the disengaged position, such as one shown in FIGS. 2E-2F. The clip member 104 may then be used as a lever or handle to rotate the shackle pin 202 about its longitudinal axis thereby causing the shackle pin 102 to be removed from both the first and second apertures of the shackle body 202. Alternatively, or additionally, the clip member 104 may be used as a lever or handle to pull the shackle pin 102 so that the shackle pin 102 can be removed from both the first and second apertures 203, 205 of the shackle body 202.

Therefore, from the above, it can be appreciated that in addition to preventing undesirable disengagement of shackle pin 102 from the shackle body 202, the clip member 104 may also act as a handle or lever to assist in the easy removal or tightening of the of the shackle pin 102 to the shackle body 202 without the need for a tool.

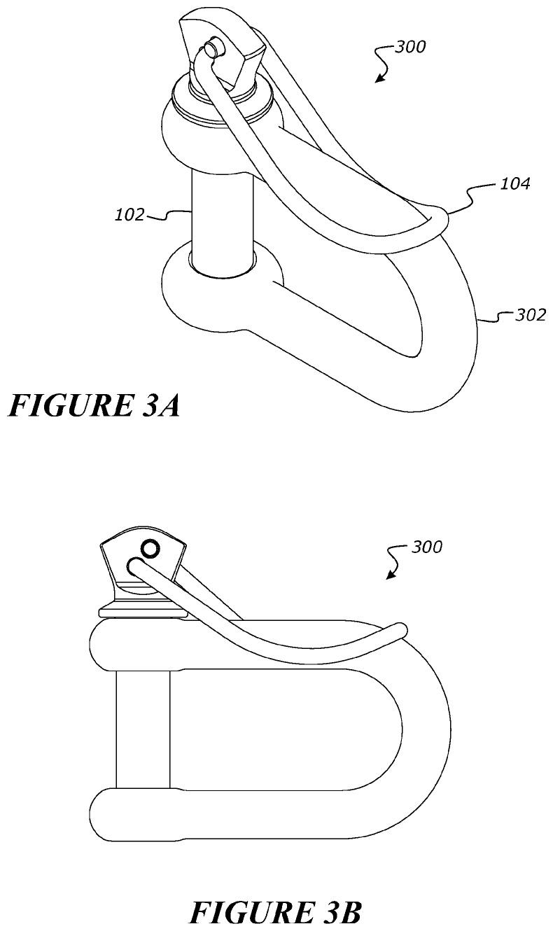

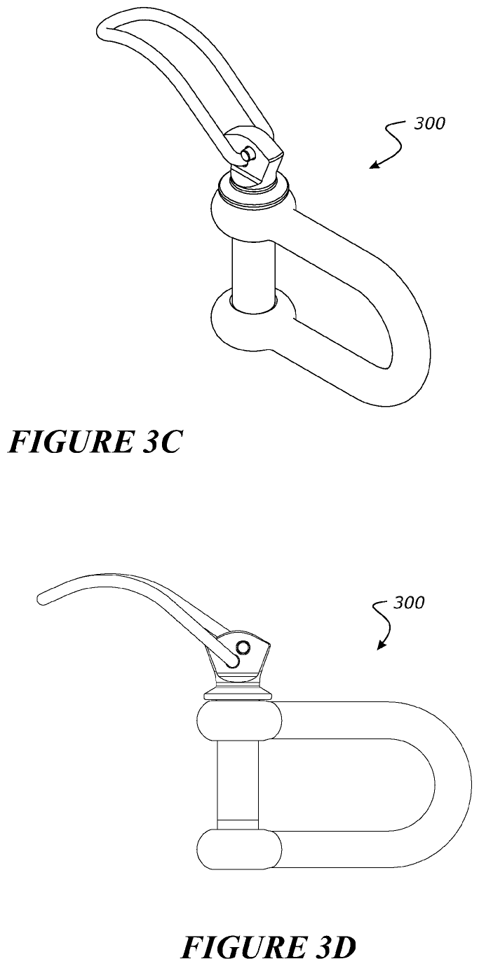

FIGS. 3A to 3D show a shackle assembly 300 according to another preferred embodiment of the present invention. As it can be seen, like the previous embodiment shown in FIGS. 2A-2E, the shackle assembly 300 also comprises a pin assembly 100 as described above with reference to FIGS. 1A-1G.

In fact, the shackle assembly 300 as shown in FIGS. 3A-3D is similar to the shackle assembly as shown in FIGS. 2A-2F, the only difference is that the shackle body 302 is U-shaped and therefore shackle assembly 300 is a D-shackle instead of a bow shackle. Other than the difference in the shape of the shackle body, the shackle assembly 300 shown in FIGS. 3A-3D are essentially the same as the shackle assembly 200 as shown in FIGS. 2A-2F. Hence, apart from the description relating to the shape of the shackle body 202, all other descriptions above with reference to FIGS. 2A to 2F, apply equally to the embodiment shown in FIGS. 3A-3D.

It is possible that the shackle body 202 may be shaped to form any other suitable shackle instead of a D-shackle or a bow shackle.

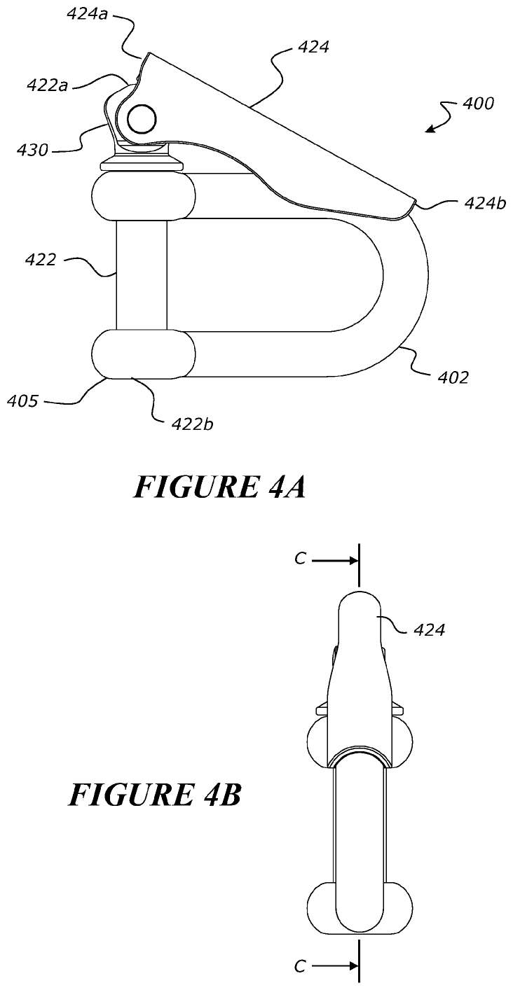

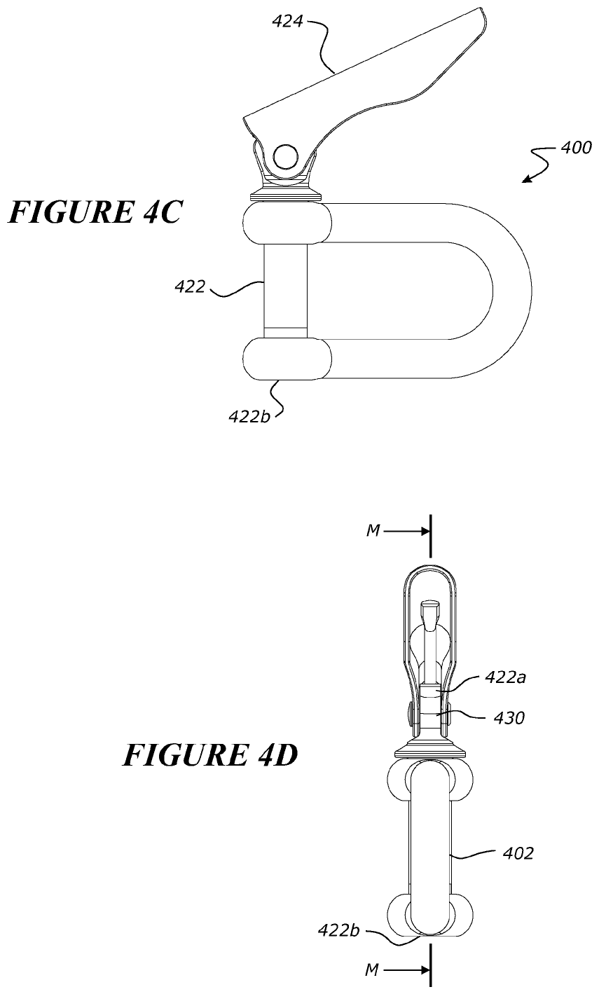

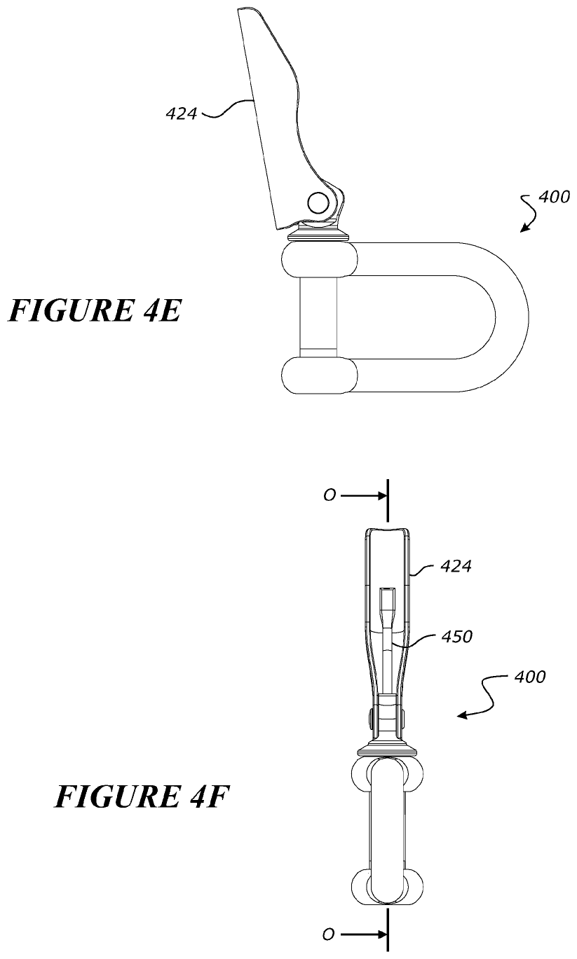

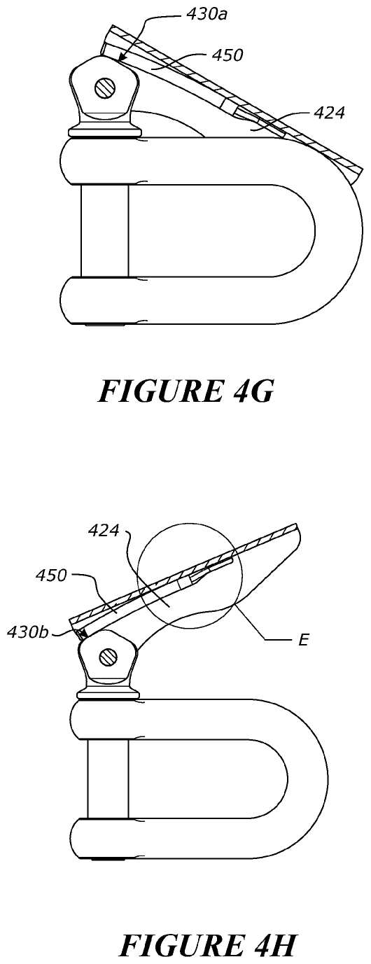

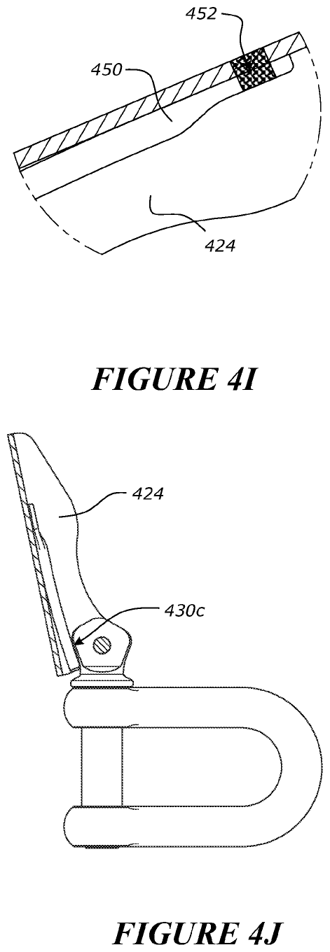

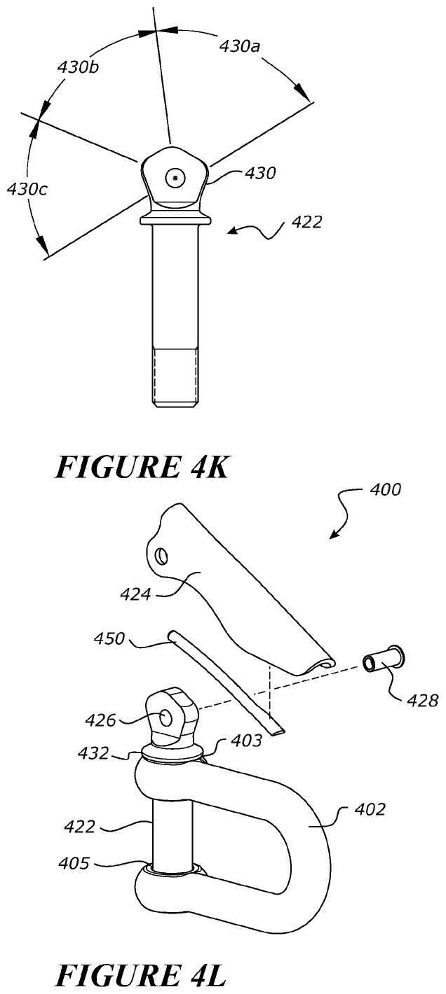

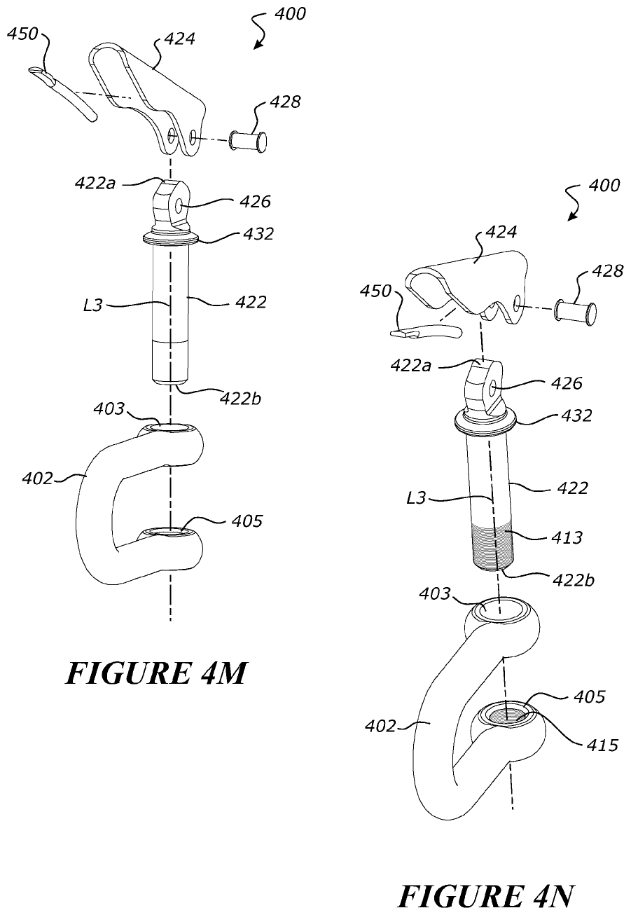

FIGS. 4A-4G show a shackle assembly 400 according to yet another preferred embodiment of the present invention. Like the shackle body 302 shown in FIGS. 3A to 3D, the shackle body 402 is also U-shaped and therefore shackle assembly 400 is a D-shackle. However, it may be possible that the shackle body 402 can be formed as a bow shackle similar to the one as described above with reference to FIGS. 2a-2f. Alternatively, the shackle body may be shaped to form other shackle instead of a D-shackle or a bow shackle.

The difference between the shackle assemblies 200, 300 of the previous embodiments and the shackle assembly 400 shown in FIGS. 4A-4F, lies in the pin assembly.

As shown in FIG. 4A, the pin assembly of shackle assembly 400 comprises a shackle pin 422 having or being in a form of an elongated body with two ends or end portions 422A, 422B that are located opposite to each other. At least one clip member 424 may be pivotally mounted to the shackle pin 422 at or near one of the two ends 422a, 422b. In the example shown in FIG. 4A, the clip member 424 is shown to be pivotably mounted to the shackle pin 422 at or near the first end 422a. The pivoting arrangement can allow the clip member 424 to pivotably move between an first position which is a closed/an engaged position as shown in FIGS. 4Aa-4B and 4G, a second position which is a midway/intermediate position (or near midway/intermediate position) in which the clip member is disengaged from the shackle body as shown in FIGS. 4C, 4D and 4H and a third position which is an open/disengaged position in which the clip member 424 is disengaged from the shackle body as shown in FIGS. 4E, 4F and 4H. Optionally, in one possible arrangement, the clip member 424 may pivotably move between only two positions, which could be either the first position and the second position, or the first position and the third position.

One example of the pivoting arrangement that facilitates the clip member 424 to move between at least two positions will now be discussed in more detail.

The shackle pin 422 may comprise a pivot facilitating feature (at or proximal to one of the first and second ends) to which at least one complimentary feature may be mounted to facilitate pivoting of the clip member 424 with respect to the shackle pin 422. As shown in FIGS. 4L and 4M, the pivot facilitating feature may comprise one hole 426 to which complimentary feature of the clip member 424 in the form of a lug 428 may be snugly and pivotably mounted to allow pivoting of clip member 424 with respect to the shackle pin 422. The lug 428 may be a bolt or a rivet or similar fastening member that is removably mounted to the clip member 424. For example, as shown in FIGS. 4L and 4M, the clip member 424 may have two apertures or cavity on two sides to which the lug 428 may be removably mounted.

Many alternative variations for pivoting arrangement other than the ones shown in the figures are possible. For example, the shackle pin 422 may comprise two lugs with one lug on each side that is configured to snugly and the same time pivotably mount with the complimentary apertures or cavities formed on two sides of the clip member 424. Similarly, two lugs may be integrated into the clip member 424 where the two lugs may be configured to snuggle and pivotably mount with a complementary aperture formed within the shackle pin 422.

The shackle pin 422 or at least a portion of it is may be of cylindrical shape as shown in FIG. 4K.

As it can be seen from FIG. 4K, one of the ends 422a of the shackle pin 422 may be formed as a gripping portion/head 430, and remaining portion of the shackle pin 422 may extend longitudinally from the head 430. The pivot facilitating feature such as a hole 426 may be formed at the head 430. In the example shown in FIGS. 4A-4G, the head 430 may be formed as a head with the remaining portion of the shackle pin 422 formed as a shaft. From FIG. 4K, it can be seen that the head 430 is of a particular shape which is different from the shape of the head 110 of the pin assembly 100 shown in FIG. 1A. Optionally, the head 430 could be of many other suitable shapes. For example, the head 430 and the shaft may both be cylindrical in shape with the diameter of the head 110 being larger than the diameter of the shaft. Similarly, the head 430 may be of same shape as head 110 as shown in FIG. 1A.

Having a head 430 of a particular shape as shown in FIG. 4k can be advantageous because that can assist clip member 424 to pivotably move between the first, second and third positions. This will now be described.

As shown in FIG. 4I, the clip member may comprise a cantilever spring 450 which may be mounted to the clip member 424 at a mounting point 452 that is proximal to second end 424b of the clip member 424 or distal to the pivot point of the clip member 424. The mounting may be done using many suitable means/techniques such as by using rivet, bolt, spot-weld etc. Alternatively, the cantilever spring 450 and clip member 424 are integrally formed, i.e. formed as one piece.

As shown in FIG. 4K, there are three external surfaces 430a, 430b, 430c formed on the head 430. The first external surface 430a may function as a close cam surface, the second external surface 430b may function as a midway/intermediate cam surface and the third external surface 430c may function as an open cam surface.

Specifically, when the clip member 402 is in the first position which is a closed/engaged position as shown in FIG. 4G, the first external surface 430a engages with at least a portion of the cantilever spring 450 that is proximal to one end 424a of the clip member 424 and can function as a cam surface, namely a close cam surface—as it can assist the clip member 424 to be and to remain in the closed position.

Similarly, when the clip member 424 is in the second position which is at or near midway position/intermediate position as shown in FIG. 4H, the second external surface 430b can engage with at least a portion of the cantilever spring 450 that is proximal to one end 424a of the clip member 424 and can function as a cam surface, namely a midway/intermediate cam surface 430b. The second external surface 430b may be called a midway/intermediate cam surface because as it can assist the clip member to be and to remain at or near the midway/intermediate position. The midway/intermediate position is still an open or disengaged position because as shown in FIG. 4H, in the midway/intermediate position the clip member 424 is still disengaged from the shackle body 402.

In the same way, when the clip member 424 is in the third position which is the open/disengaged position as shown in FIG. 4H, the third external surface 430c engages with at least a portion of the cantilever spring 450 that is proximal to the first end 424a of the clip member 424 and can function as a cam surface, namely an open cam surface. The third external surface 430c may be called an open cam surface is because as it can assist the clip member to be and to remain in the open position.

It can be appreciated that specific shape of external surfaces 430a, 430b, 430c allow them to function as cam surfaces, which means that external surfaces 430a, 430b, 430c assist in pivoting of the clip member 424 between first, second and third positions, but at the same time also prevent the clip member 424 from accidently move between first, second and third positions, unless an external force is applied.

Preferably, there is a releasable locking mechanism (not shown) so that when the clip member 424 is in a particular position and when the locking mechanism is in the locked position, the clip member 424 is prevented from moving to any other position even when the external force is applied.

The shackle pin 422 may comprise a flange 432 adjacent of the head 430. As shown, the flange 432 may abut against a portion of the shackle body 402 where one of the apertures, in this example aperture 403, that is proximal to the clip member 424 is located. The flange 432 of the shackle pin 422 may therefore be sandwiched/located between the shackle body 402 and the head 430.

The clip member 424 may be formed from a panel that is bent on two sides as shown in FIGS. 4A-4M. The clip member 424 may be dimensioned, shaped and/or have features such as tabs allowing it to engage (such as via snug fit or snap fit arrangement or spring force/under spring tension) to a shackle body 402. Similar to the clip member 104 as described above with reference to FIGS. 1A-1G and 2A-2F, the clip member 424 may also function as a lever or handle for facilitating rotation of the shackle pin 422 about longitudinal axis L3 of the shackle pin 422 when in the second or third positions. The clip member 424 may be made from a metal such as but not limited to steel, aluminium, stainless steel (e.g. 316SS) and/or Titanium (e.g. 6A1-4V (Grade 5)). Alternatively, the clip member 424 may be made from a suitable nonmetal such as but not limited to plastic and/or carbon fibre.

As mentioned previously, the shackle body 402 is substantially the same as the shackle body 302 as described above with reference to FIGS. 3A-3D, and the shackle body 302 (apart from its shape) is substantially the same as the shackle body 202 as described above with reference to FIGS. 2A-2F. Therefore, the shackle body 402 need not be described in further detail.

To attach the shackle pin 422 to the shackle body 402, the shackle pin 422 may be first inserted into the first and second apertures 403, 405 of the shackle body 402 so that both the first and second apertures 403, 405 of the shackle body 402 receives the shackle pin 422 therethrough. If needed, the clip member 424 may be used as a lever or a handle to rotate the shackle pin 422 about its longitudinal axis L3 of the shackle pin L3 thereby causing the shackle pin 422 to be properly and tightly received through both the first and second apertures 403, 405 of the shackle body 402. The clip member 424 may function as the lever or the handle more effectively when it is in the second position as shown in FIGS. 4C-4D as compared to the third position as shown in FIGS. 4E-4F. It can be appreciated that if the shackle pin 422 comprises a threaded arrangement/threaded portion that is configured to engage with a complementary threaded arrangement/threaded portion in at least one of the first and second apertures 403, 405 of the shackle body 402, then using the lever in such a manner can also assist in tightly engaging/securing the shackle pin 422 to the apertures 403, 405 of the shackle body. FIG. 4N shows threaded portion 413 formed on the shackle pin 422 and the complementary threaded portion 415 formed on the shackle body 402, specifically within the aperture 405 of the shackle body 405. The shackle body 202 or 302 as described above and shackle body 502 as described below may also comprises may also comprise similar threaded portion. Such a threaded arrangement can further allow or assist the shackle pin 422 to be secured to the shackle body 402. However, it can be appreciated that even if threaded portion 413 and complementary threaded portion 415 are not tightly engaged, the shackle pin 102 may still remain secured to the shackle body 202 due to the clip member 424 being engaged to the shackle body 402. Therefore, the engagement at the threaded portions 413, 412 no longer has to be tight in order to be secure. That is, as long as the shackle pin 422 is properly engaged into the shackle body 402, and the clip member 424 is in the secure position, the functionality of the shackle is not compromised, thus negating the necessity to have the shackle pin 412 screwed in tight for security. Of course, it can be appreciated that such threaded arrangement is preferable but is optional. The engagement of clip member may provide sufficient engagement of the shackle pin 422 and the shackle body 402 to allow the shackle assembly 400 to function as normal without requiring any additional engagement features including threaded arrangements.

Once the shackle pin 422 is properly received within the apertures 403, 405, the clip member 424 may be pivotably moved from a disengaged position (second or third positions), such as one shown in FIGS. 4c-4f to an engaged position (first position) such as one shown in FIGS. 4a-4b. By engaging with the shackle body 402 in such a manner, the clip member 424 can function as a safety keeper or a catch. The engagement of the clip member 424 to the shackle body 202 may allow the shackle pin 412 to be secured to the shackle body 402. The engagement of the clip member 424 to the shackle body may allow the shackle pin 412 to remain secured to the shackle body 402 without necessary requiring any other engagement features. A person skilled in the art will appreciate that such clip member 424 can then prevent (or assist to prevent) unintentional rotation of the shackle pin 422 thereby preventing (or assist in preventing) disengagement of the shackle pin 422 from the shackle body 402.

To detach or disengage the shackle pin 422 from the shackle body 402, the above described method/process may be reversed. Specifically, clip member 424 may first be pivotably moved from an engaged position (first position) such as one shown in FIGS. 4A-4B to a disengaged position, such as one shown in FIGS. 4C-4F. The clip member 424 may then be used as a lever or a handle to rotate the shackle pin 422 about its longitudinal axis L3 thereby causing the shackle pin 422 to be removed from both the first and second apertures 403,405 of the shackle body 402. Again, the clip member 424 may function as the lever or the handle more effectively when it is in the second position as shown in FIGS. 4C-4D as compared to the third position as shown in FIGS. 4E-4F. Alternatively, or additionally, the clip member 424 may be used as a lever or a handle to pull the shackle pin 422 so that the shackle pin 422 can be removed from both the first and second apertures 403, 405 of the shackle body 402.

Therefore, from the above, it can be appreciated that in addition of preventing undesirable disengagement of shackle pin 422 from the shackle body 402, the clip member 424 may also act as a handle or a lever to assist in the easy removal or tightening of the of the shackle pin 422 to the shackle body 402 without the need for a tool.

As described above, during the disengaged position, the clip member 424 may be either be in the third position as shown in FIGS. 4E-4F or in the second position as shown in FIGS. 4C-4D. The clip member 424 may function as a lever or a handle in either of those two positions, although functioning as the lever in the second position is most preferred. Even if the head 430 is not shaped to provide cam surfaces as described above, the clip member may still be configured to be locked (due to tight fit or many other suitable arrangements) in either of the positions shown in FIG. 4E or 4F so that it stays in that position without easily pivoting to another position.

From the above description, it can be appreciated that apart from the difference in the pin assembly, including the ability of the clip member 424 to move between at least three positions, and apart from the shape of the shackle body all other functionalities of the shackle assembly 400 are essentially the same as those of the shackle assembly 200 as described above with reference to FIGS. 2A-2F.

Some non-limiting examples of the variations may include:
Forming clip member 424 from wire (open or closed loop wire) instead of panel. For example, a clip member 424 may be formed from a wire which is attached/mounted to a cantilever spring that is adapted to engage with the external surfaces 430a, 430b, 430c of the head 430 in order to facilitate the clip member 424 to move between three positions.
The clip member 424 may be configured to move between more than three positions. For example, the head 430 may be shaped to form more than three cam surfaces and the cantilever spring 450 that may be adapted to engage with the external surfaces 430a, 430b, 430c of the head 430 in order to facilitate the clip member 424 to move between more than three positions.

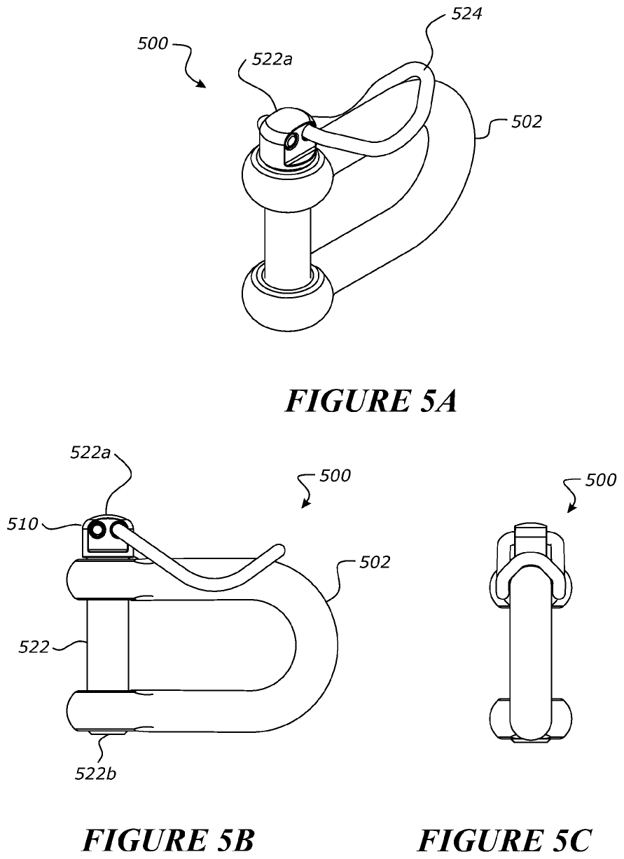

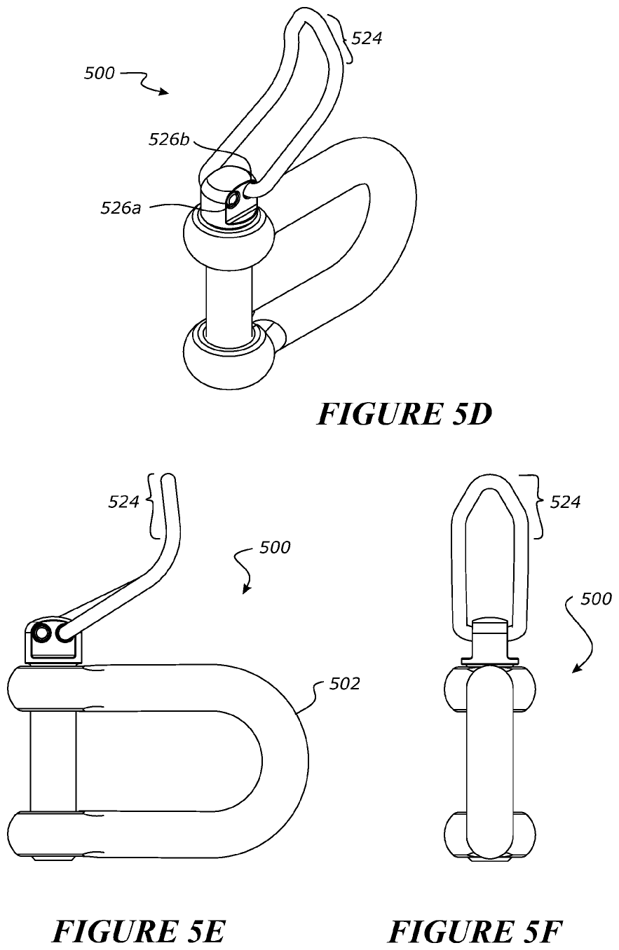

FIGS. 5A-5F show a shackle assembly 500 according to another preferred embodiment of the present invention. Similar to the shackle body 302 shown in FIGS. 3A to 3D, the shackle body 502 is also U-shaped and therefore shackle assembly 500 is a D-shackle. However, it may be possible that the shackle body 502 can be formed as a bow shackle similar to the one as described above with reference to FIGS. 2A-2F. Alternatively, the shackle body may be shaped to form any other suitable type of shackle instead of a D-shackle or a bow shackle.

The difference between the shackle assemblies 200, 300 of the previous embodiments and the shackle assembly 500 shown in FIGS. 5A-5F, primarily lies in the pin assembly, particularly in the pivot facilitating feature and the in the shape of the clip member. Most of the features and functionalities of the shackle assembly 500 may be the same as those of the shackle assembly 200 as described above with reference to FIGS. 2A-2F and therefore only the differences will be described in detail.

As shown in FIG. 5A, the pin assembly of shackle assembly 500 comprises a shackle pin 522 having or being in a form of an elongated body with two end portions or two ends 522A, 522B that are located opposite to each other. At least one clip member 524 may be pivotally mounted to the shackle pin 522 at or near one of the two ends 522A, 522B. In the example shown in FIG. 5A-5F, the clip member 524 is shown to be pivotably mounted to the shackle pin 522 at or near the first end 522a. The pivoting arrangement can allow the clip member 524 to pivotably move between a first position which is a closed or an engaged position as shown in FIGS. 5A-5C and a second position which is an open or disengaged position in which the clip member 524 is disengaged from the shackle body as shown in FIGS. 5D-5F.

One example of the pivoting arrangement that facilitates the clip member 524 to move between the two positions will now be described.

The shackle pin 522 may comprise a pivot facilitating feature (at or proximal to one of the first and second ends) to which two complimentary features may be mounted to facilitate pivoting of the clip member 524 with respect to the shackle pin 522. As shown in FIGS. 5A, 5B, 5D and 5E, the pivot facilitating feature may comprise two holes 526a, 526b to which complimentary features of the clip member 524 (in this case two ends of the open loop of the clip member 524) may be snugly and pivotably mounted to allow pivoting of clip member 524 with respect to the shackle pin 522.

The two holes 526a, 526b are located adjacent to each other and at the same height from the second end 422b of the shackle pin 422. The two holes 526a, 526b are located/formed in the head 510. The two holes 526a, 526b are identical to each other in size and shape.

As shown in FIGS. 5A-5F, an upwardly extending portion 524a may be formed in the clip member 524 extending in an upward direction from remaining portion of the clip member 524. The upwardly extending portion may be 90 degrees or substantially 90 degrees from the remaining portion of the clip member 524. As shown in FIG. 5E, the upwardly extending portion 524a may be distally located from the shackle pin. The upwardly extending portion 524a may be located distal from the pivot point and may be located at the portion of the clip member 524 that is furthest from the shackle pin 524 or pivot point or head 510. As shown in FIGS. 5D-5F, the upwardly extending portion 524 may point in an upward direction which means when the clip member 524 is in a disengaged position as shown in FIGS. 5D-5F, the upwardly extending portion 524 may be gripped by a user to further assist in rotation and removal of the shackle pin 502 from the shackle body 502. Specifically, the user may simply grip the upwardly extending portion 524a of the clip member 524 to rotate and remove the shackle pin 522 from the shackle body 502. As shown in FIGS. 5A-5C, during the engaged position, whole or at least the significant portion of the upwardly extending portion 524a may snugly engage with the portion of the shackle body 502. As shown, during the engaged position, the first end 522a of the shackle pin 522 is higher than the upwardly extending portion 524.

From the above description, it can be appreciated that apart from the differences as explained above, all other features and functionalities of the shackle assembly 500 may be the same as those of the shackle assembly 200 as described above with reference to FIGS. 2A-2F. The shackle pin 522 may also optimally comprises threaded portion similar to threaded portion 113 to engage with complementary threaded complementary portion formed in the shackle body 502.

It can be appreciated the clip member 104 as described above may also comprise upwardly extending portion similar to the clip member 524.

It will of course be realised that while the foregoing has been given by way of illustrative example of the present invention, all such modifications and variations thereto as would be apparent to a person skilled in the art are deemed to fall within the broad scope and ambit of the various aspects of invention as is hereinbefore described and/or defined in the claims.

### Advantages

Some of the advantages of the present invention are as follows:
Simpler design
Preventing (or assists in preventing) undesirable disengagement of the shackle pin from the shackle body
Clip member can act as a handle or lever to assist in the easy removal or tightening of the shackle pin to the shackle body without the need for a tool
Shackle pin can be secured to the shackle body using only the clip member without necessarily requiring additional engagement means
Clear visual identification of a secured shackle condition
Clear visual identification of an unsecured shackle condition
Smoother Shackle Pin profile that will resist snagging
Improved visual appeal of the shackle

1. A shackle assembly comprising:
a shackle body comprising a first portion, a second portion and an intermediate portion connecting the first and the second portions, the first and the second portions being spaced apart and located opposite to each other, the first portion comprising a first aperture and the second portion comprising a second aperture;
a shackle pin in a form of an elongated body extending along a longitudinal axis of the shackle pin from a first end of the shackle pin to a second end of the shackle pin, wherein the first end and the second end are located opposite to each other, the shackle pin being configured to be attached to the shackle body so that the first and second apertures of the shackle body are both adapted to receive the shackle pin therethrough, thereby functioning as a cross member to the shackle body; and
a clip member, the clip member being pivotally mounted to the shackle pin at a pivoting point located at or near one of the first and second ends,
the clip member is adapted to pivotally move with respect to the longitudinal axis of the shackle pin between at least a first position where the clip member is adapted to engage to the shackle body, and a second position where the clip member is adapted to be disengaged from the shackle body and function as a lever for facilitating rotation of the shackle pin about the longitudinal axis.

2. A shackle assembly as claimed in claim 1, wherein the clip member is adapted to engage to the shackle body via a snug fit or a snap fit arrangement or via a spring force.

3.-9. (canceled)

10. The shackle assembly as claimed in claim 1, wherein the clip member is made from a single piece of wire that is bent.

11. The shackle assembly as claimed in claim 1, wherein the clip member is made from a single piece wire that is formed as a loop that is an open or a closed loop.

12. The shackle assembly as claimed in claim 11, wherein the loop of the wire is configured to engage with the portion of the shackle body that is proximal to the clip member for assisting the shackle pin to remain engaged with the first and second apertures of the shackle body.

13. The shackle assembly as claimed in claim 1, wherein the clip member or at least a portion of the clip member is formed as a curve or substantially a curve.

14. The shackle assembly as claimed in claim 1, wherein an upwardly extending portion is formed on the clip member, the upwardly extending portion extending in an upward direction from remaining portion of the clip member.

15. (canceled)

16. The shackle assembly as claimed in claim 1, wherein the upwardly extending portion is located distal from the shackle pin.

17.-21. (canceled)

22. The shackle assembly as claimed in claim 1, wherein the shackle pin and the shackle body are both made from same material.

23.-29. (canceled)

30. The shackle assembly as claimed in claim 1, wherein the clip member is spring loaded.

31. The shackle assembly as claimed in claim 1, wherein the clip member is biased to either a closed position in which the clip member is configured to engage with the shackle body during use or to an open position in which the clip member is configured to disengage with the shackle body during use.

32. The shackle assembly as claimed in claim 1, wherein the clip member is spring biased to either a closed position in which the clip member is configured to engage with the shackle body during use or to an open position in which the clip member is configured to disengage with the shackle body during use.

33. The shackle assembly as claimed in claim 1, wherein at or near one of the first and second ends of the shackle pin is a head through which the remaining portion of the shackle pin extends longitudinally as a shaft and wherein the head is sized and shaped to function as a gripping portion to facilitate gripping by a user's fingers and/or a gripping tool.

34.-36. (canceled)

37. The shackle assembly as claimed in claim 33, wherein the head comprises at least two cam surfaces that are adapted to facilitate pivoting of the clip member between at least the first position and the second position.

38. The shackle assembly as claimed in claim 33, wherein the head comprises at least three cam surfaces that are adapted to facilitate pivoting of the clip member between at least the first position, the second position and a third position, and wherein when the clip member is in the third position, a portion or end of the clip member that is distal to a pivot point of the clip member is more distal to the shackle body than when the clip member is in the second position.

39. (canceled)

40. The shackle assembly as claimed in claim 33, wherein the clip member comprises a cantilever spring that is adapted to engage with one of the cam surfaces to allow the clip member to be and remain in a particular position.

41. The shackle assembly as claimed in claim 40, wherein the cantilever spring is mounted to the clip member at a mounting point that is proximal to an end of the clip member that is distal to the pivot point of the clip member.

42. (canceled)

43. The shackle assembly as claimed in claim 33, wherein the shackle pin comprises a flange adjacent to the head.

44.-50. (canceled)

51. A shackle assembly comprising:
a shackle body having a first portion, a second portion and an intermediate portion connecting the first and the second portions, the first and the second portions being spaced apart and located opposite to each other, the first portion comprising a first aperture and the second portion comprising a second aperture; and
a cross member extending along a longitudinal axis of the cross member from a first end of the cross member to a second end of the cross member, wherein the first end and the second end are located opposite to each other, the cross member having a clip member that is pivotally attached to the cross member at or proximal to one of the first and second ends;
wherein when in an assembled position, the cross member is configured to be attached to the body so that the first and second apertures of the shackle body are both adapted to receive the cross member therethrough,
wherein when in the assembled position, the clip member is adapted to pivotally move with respect to the cross member between a secure position and an unsecured position,
wherein when in the secured position the clip member is configured to engage with a portion of the shackle body that is proximal to the clip member for allowing or at least assisting the cross-member to remain in the assembled position, and
wherein when in the unsecured position, the clip member is configured to disengage with the shackled body and function as a lever for assisting in full or partial detachment of the cross member from the shackle body

52. A clip member for clipping to a portion of a shackle body, the clip member being adapted to engage with a shackle pin that is elongated and extends along a longitudinal axis of the shackle pin from a first end of the shackle pin to the second end of the shackle pin, wherein the clip member is adapted to engage pivotally at or near either one of the first end and the second end of the shackle pin, wherein when engaged with the shackle pin, the clip member is adapted to function as a lever for facilitating rotation of the shackle pin about the longitudinal axis.

53-64. (canceled)
